(19) United States
(12) Patent Application Publication
(10) Pub. No.: US 2021/0370327 A1
(43) Pub. Date: Dec. 2, 2021

(54) PAINT SPRAY GUN

(71) Applicant: BELLASSA GMBH, HAMBURG (DE)

(72) Inventors: MICHAEL PFINGSTGRAEF, BAD SCHWARTAU (DE); BJOERN BUCHHOLZ, LUEBECK (DE)

(21) Appl. No.: 17/297,860

(22) PCT Filed: Dec. 4, 2018
(86) PCT No.: PCT/EP2018/083489

§ 371 Date: May 27, 2021

(51) Int. Cl. B05B 7/24; B05B 7/00; B05B 7/08; B05B 1/30

(52) U.S. Cl. CPC B05B 7/2478; B05B 7/0081; B05B 1/3046; B05B 7/2416; B05B 7/2435; B05B 7/0815

(57) ABSTRACT

The invention relates to a paint spray gun, comprising a tubular main body and a handle which is provided on the main body and has an actuatable trigger, wherein the main body has a spray opening on a first end face. The paint spray gun comprises a nozzle part arranged in the main body and a nozzle needle which can be moved in the nozzle part, wherein actuation of the trigger causes the nozzle needle to move in the nozzle part. The paint spray gun also comprises an air inlet opening and a fan which is driven by an electric motor for producing an air flow from the air inlet opening to the spray opening. The invention is characterised in that the electric motor and the fan are arranged in the main body and the air inlet opening is arranged on an end face of the main body opposite the first end face.

The present invention relates to a paint spray gun comprising a tubular main body and a handle which is provided on the main body and has an actuatable trigger, the main body having a spray opening on a first end face, said paint spray gun also comprising a nozzle part arranged in the main body and a nozzle needle that is movable in the nozzle part, with actuation of the trigger causing the nozzle needle to move in the nozzle part, as well as an air inlet opening and a fan which is driven by an electric motor and provided for generating an air flow between the air inlet opening and the spray opening.

Such a paint spray gun is known from WO 2013/072500 A1. DE 20 2014 105 806 U1 discloses a further developed paint guide for such a paint spray gun. In these designs, the motor and fan are located at the lower end of the handle so that the tool has a low centre of gravity, but this makes the paint spray gun so long in the vertical direction as to be unwieldy. Furthermore, the air flow here flows through the handle, with the flow resistance increasing due to the cross-sectional reduction in the handle, which either leads to a reduction in performance or has to be compensated for by a larger and more powerful electric motor.

The problem addressed by the invention is that of providing an easy-to-handle, compact and powerful paint spray gun, in particular for DIYers.

The invention solves this problem by means of the features of the independent claims. Due to the arrangement, according to the invention, of the electric motor and the fan in the main body and the arrangement of the air inlet opening on an end face of the main body opposite the first end face, the length of the paint spray gun can be reduced in the vertical direction, which improves the handling of the tool. Since the main body can be designed with a larger cross section than the handle, according to the invention, a stronger air flow can also be generated due to the larger flow cross section in the main body without having to use a more powerful electric motor.

A filter for filtering the air flow flowing through the main body is advantageously provided in the region of the air inlet opening in order to prevent the ingress of dirt and dust and, at worst, obstruction of the nozzle. The filter is preferably held on the main body by a filter cap through which a flow can pass. The filter cap can in particular be detached or folded back from the main body in order to allow the filter to be replaced.

A coupling pin is advantageously provided for transmitting the actuating forces from the trigger to the nozzle needle. In the assembled state, the coupling pin passes through an eye, for example, which is arranged on the side of the nozzle needle opposite the tip. Particularly advantageously, the nozzle part also has at least one through-opening through which the coupling pin can pass, the coupling pin passing through the through-opening of the nozzle part in the assembled state. This effectively prevents the nozzle part from being pulled out of the main body in the assembled state and, as a result, prevents the main body from being contaminated with paint residue. The through-opening is advantageously designed as a slot hole so that the coupling pin can be moved in the through-opening.

The coupling pin particularly advantageously has a grip which allows an operator to manually pull the coupling pin out of the main body. The grip advantageously has a larger diameter than the part of the coupling pin that extends inside the main body so that it can be gripped by the operator in order to transmit sufficient tensile forces.

The paint spray gun preferably has an on/off switch which can be switched independently of the actuation of the trigger and is provided for switching the fan on and off. This improves the metering capability of the paint spray gun because the fan can be switched on over the entire movement path of the trigger and is not, as in the prior art, switched on only after a defined movement path has been covered by the trigger.

The paint spray gun preferably has an accumulator for supplying the electric motor with electricity, so that the range and handling of the paint spray gun is not limited and restricted by the length of an electrical mains supply line. The electrical accumulator is particularly advantageously arranged on the side of the handle opposite the main body, i.e. at the lowest point of the paint spray gun. The low centre of gravity which can be achieved in this way facilitates handling and advantageously counteracts an elevation of the centre of gravity by relocating the electric motor and the fan to the main body.

The electrical accumulator is advantageously arranged in an accumulator unit that can be removed from the paint spray gun. This allows an empty accumulator to be exchanged for a charged accumulator so that the spraying operation does not have to be interrupted for the accumulator to be charged.

Guide elements for a rotary closure of the paint container unit are preferably provided in a receptacle for receiving a paint container. These can interact with advantageous guide elements on a rotary closure of a paint container unit, such that a rotation of the paint container relative to the paint spray gun causes the rotary closure to open or close depending on the direction of rotation.

The invention will be explained below on the basis of preferred embodiments with reference to the accompanying drawings. Thereby shows

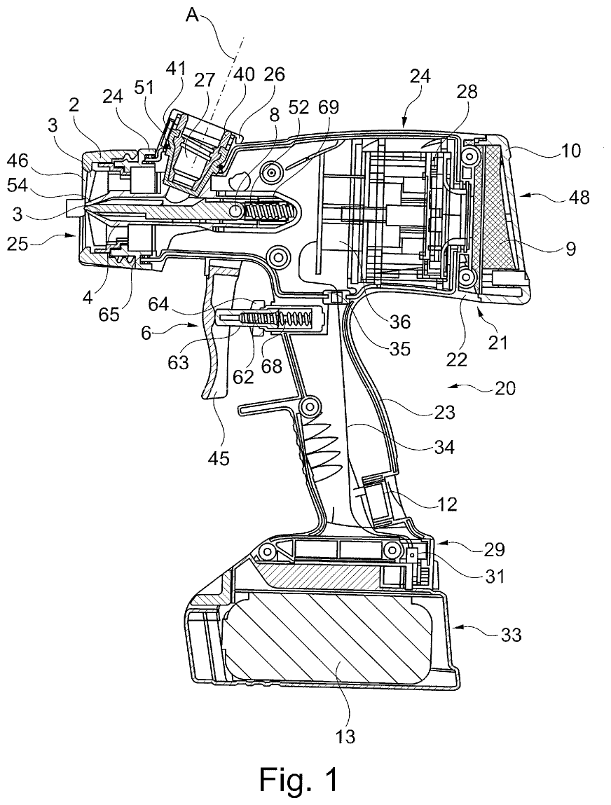

FIG. 1 a cross section through a paint spray gun;

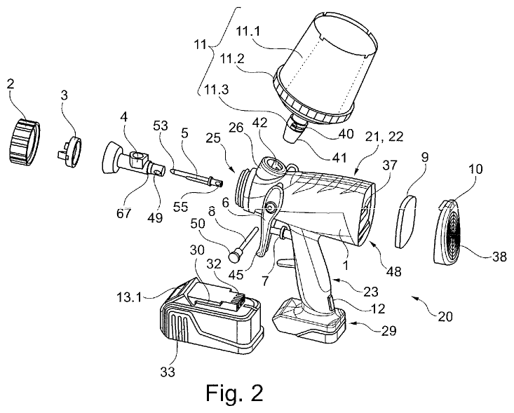

FIG. 2 a perspective exploded view of a paint spray gun with the accumulator unit removed; and

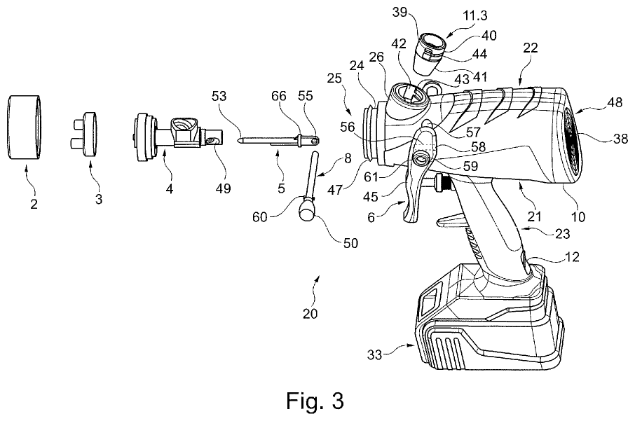

FIG. 3 is a perspective exploded view of a paint spray gun with the accumulator unit inserted.

The paint spray gun 20 comprises a pistol-shaped housing 21 which forms a tubular main body 22 and a handle 23 for an operator to hold the paint spray gun 20. The main body 22 is arranged above the handle 23. The tubular main body 22 has an air inlet opening 37 on a rear end face 48 and an air outlet opening or spray opening 46 on the opposite front end face 25. On the top of the tubular main body 22, a pipe socket 26 is provided which forms a receptacle 27 for a paint container unit 11 for supplying paint. The receptacle 27 can also be formed completely inside the main body 22, so that a pipe socket 26 can be dispensed with. The pipe socket 26 or the insertion axis A of the receptacle 27 can be inclined to the rear with respect the vertical, for example in the range between 10° and 30°.

An electric motor 28 is arranged in the tubular main body 22. An accumulator 13 is advantageously provided for supplying power to the electric motor 28. The accumulator 13 is advantageously arranged in an accumulator unit 33 on the underside of the handle 23.

The accumulator unit 33 can advantageously be removed from the paint spray gun 20 so that an empty accumulator 13 can be exchanged for a charged accumulator 13 and the spraying operation does not have to be interrupted for the accumulator 13 to be charged. The paint spray gun 20 therefore advantageously has an electro-mechanical accumulator interface 29, which is advantageously arranged on the underside of the handle 23, and a mechanical guide which interacts with a corresponding guide 30 of the accumulator unit 33, and electrical contacts 31 for interacting with corresponding electrical contacts 32 of the accumulator unit 33.

Furthermore, a locking device can be provided which locks the accumulator unit 33 on the accumulator interface 29 as a result of the connection thereto. In order to release the locking device and allow the accumulator unit 33 to be removed from the paint spray gun 20, an unlocking button 13.1 is advantageously provided on the accumulator unit 33, or alternatively on the accumulator interface 29.

The accumulator 13 or the electrical contacts 31 are connected to the electric motor 28 via a cable 34, which is advantageously guided through a cable bushing 35 between the handle 13 and the main body 22. The power supply of the electric motor 28 can be switched on and off by an operator by means of a switch 12 arranged in the housing 1. If and for as long as the switch 12 is in the switched-on position, the electric motor 12 drives a fan 36, which generates an air flow from the air inlet opening 37 to the air outlet opening 46 in the tubular main part 22.

A filter 9 for filtering the air flowing through the main body 22 can advantageously be provided in the region of the air inlet opening 37. The filter 9 is advantageously held by a filter cap 10 provided with through-flow openings 38 in such a way that it completely covers the air inlet opening 37. For a user to change the filter 9, the filter cap 10 can advantageously be removed or folded back from the housing 1.

A paint container unit 11 can be connected to the paint spray gun 20. The paint container unit 11 comprises a paint container 11.1, a paint container cover 11.2 comprising a paint discharge opening, and a closure part 11.3 for reversibly closing the paint discharge opening. The closure part 11.3 comprises two portions 40, 41, namely a portion 40 which is secured to the container and a portion 41 which can be rotated relative to the container 11.1.

When a paint container 11.1 is inserted into the receptacle 27, the closure part 11.3 is opened as a result of a rotation of the rotatable portion 41 relative to the paint container 11.1 so that the paint can flow from the paint container 11.1 into the paint spray gun 20. When a paint container 11.1 is removed from the receptacle 27, the closure part 11.3 is closed as a result of a rotation of the rotatable portion 41 relative to the paint container 11.1 in the opposite direction in order to prevent paint from inadvertently leaking out of the paint container 11.1.

The rotation of the rotatable portion 41 relative to the paint container 11.1, and consequently the rotary closure described above, is advantageously brought about by means of interacting guide elements 39, 42-44 on the closure part 11.3 and in the receptacle 27. Advantageously, the rotatable portion 41 of the closure part 11.3 has a projection 44 and/or the non-rotatable portion 40 of the closure part 11.3 has a projection 39, which projections extend in corresponding grooves 42, 43 in the receptacle 27, as will be explained below. A groove 42 extending in an axially parallel manner from the outer edge of the receptacle 27 and a circumferential groove 43 which branches off said groove and is axially spaced from the outer edge of the receptacle 27 are advantageously provided; see FIG. 3. Alternatively, it is possible for the projections 39, 44 to be provided in the receptacle 27 and for the grooves 42, 43 to be provided in the portions 40, 41.

The insertion of a paint container unit 11 into the receptacle 27 is described below. In the state shown in FIG. 2, the rotary closure part 11.3 is closed in order to prevent unintentional leakage of paint from the paint container 11.1. In this state, the projections 39, 44 are aligned in the axial direction.

The paint container unit 11 is then first pushed or inserted linearly into the receptacle 27 axially along an insertion axis A (see FIG. 1) which corresponds to the longitudinal axis of the receptacle 27 or of the pipe socket 26, the projections 39, 44 being guided in the axially parallel groove 42 until a stop is reached and no further insertion is possible. The paint container 11.1 is then rotated, for example clockwise, the projection 44 being held in the groove 42 and the projection 39 running in the circumferential groove 43 until a stop is reached and no further rotation is possible. As a result of the rotation, the rotatable portion 41 is rotated relative to the non-rotatable portion 40 and the rotary closure part 11.3 is opened such that paint can run into the nozzle part 4 by means of gravity.

The removal of the paint container unit 11 from the receptacle 27 in carried out in the reverse order, i.e. the paint container 11.1 is first rotated in the opposite direction, for example counter-clockwise, the projection 44 being held in the groove 42 and the projection 39 running in the circumferential groove 43 until a stop is reached and no further rotation is possible. As a result of the rotation, the rotatable portion 41 is rotated relative to the non-rotatable portion 40 and the rotary closure part 11.3 is closed such that paint is prevented from leaking out of the paint container unit 11. After the rotation, the paint container unit 11 can be pulled out linearly along the insertion axis A, the projections 39, 44 being guided in the axially parallel groove 42. An elastomeric sealing element 51, for example an O-ring, which sealingly interacts with the rotary closure 11.3 can be provided in the receptacle 27.

In the main body 22, a nozzle part 4, a nozzle needle 5 and an air cap 3 are provided which can be inserted into the main body from the front end face 48 when the receptacle 27 is free, i.e. when there is no paint container unit 11 inserted in the receptacle 27. The unit which is inserted into the main part 22 and consists of the nozzle part 4, nozzle needle 5 and air cap 3 is held in the main part 22 by means of an air cap ring 2 that can be screwed onto the main part 22 on the front end face 25. For this purpose, the main part 22 can have a front housing ring 24 comprising a thread 47 which interacts with a thread of the air cap ring 2. The housing ring 24 can be sealed against the main body 22 by means of a sealing ring 65.

At an end opposite the tip 53, the nozzle needle 5 has an eye 55 which can be passed through. The nozzle part 4 has a through-opening 49 at the rear end thereof. After the nozzle part 4 and the nozzle needle 5 have been inserted into the main body 22, the coupling pin 8 is pushed laterally into the main body 22, the coupling pin 8 passing through both the eye 55 of the nozzle needle 5 and the through-opening 49 of the nozzle part 4. For this purpose, the housing of the main part 22 advantageously has a guide opening 56 (shown only schematically in FIG. 3) on one or both sides through which the coupling pin 8 passes in the assembled state. The guide opening 56 can in particular be a slot hole which extends in the longitudinal direction of the main body 22.

The paint spray gun 20 has a manually actuatable trigger or trigger lever 6 which is articulated on the main body 22 so as to be pivotable about a pivot shaft 57. The pivot shaft 57 is advantageously arranged above the guide opening 56, as can be seen in FIG. 1. The trigger lever 6 preferably has two side plates 58 which are arranged on both sides of the main body 22 and articulated on the pivot shaft 57, and an actuating portion 45 in which the side plates 58 converge at the bottom so that the trigger lever 6 is Y-shaped when viewed from the front. The actuating portion 45 can be actuated in the manner of a pistol trigger with the fingers of a hand enclosing the handle 23. In one or advantageously both side plates 58, a through-hole 59 is provided through which the coupling pin 8 is pushed during assembly.

After the coupling pin 8 has been pushed into the main body 22, with the coupling pin 8 consecutively passing through the through-hole 59, the guide opening 56, the through-opening 49 and the eye 55, the coupling pin 8 can advantageously be locked, for example by means of rotation, for which purpose the grip 50 and the side plate 58 preferably have interacting locking elements 60, 61.

In the state in which the coupling pin 8 is pushed into the main body 22, the nozzle part 4 and the nozzle needle 5 are effectively prevented from being inadvertently pulled out of the main body 22 by means of the through-opening 49. This is particularly advantageous after the paint spray gun 20 has been used in order to prevent unintentional leakage of paint from the nozzle part 4 into the main body 22.

After the coupling pin 8 has been pushed into the main body 22, the air cap 3 is inserted into the main body 22 and the air cap ring 2 is then screwed onto the main body 22. The paint container unit 11 can then be inserted into the receptacle 27 as described above and locked therein. In this assembled and ready-to-use state of the paint spray gun 20 shown in FIG. 1, the trigger lever 6 is preloaded forwards by means of a spring 62 and a spring bushing 63. The spring 62 can be guided on a spring pin 68 which is secured to the housing. Furthermore, a paint-quantity-regulating screw 64 can be provided by means of which the rear stop of the trigger lever 6 can be varied.

In the assembled state shown in FIG. 1, the nozzle needle 5 is held in the nozzle part 4 so as to be movable in a longitudinal direction of the main part 22. The nozzle needle 5 is preloaded forwards, i.e. in the direction of the front end face 25, by means of a spring 52. The spring 52 can be guided in a spring bushing 69 which contacts the nozzle needle 5 at the front end thereof.

A tip 53 is provided on the front of the nozzle needle 5. A nozzle 54 is provided on the front of the nozzle part 4. In the idle position, the spring 52 presses the tip 53 of the nozzle needle 5 into a nozzle 54 and closes said nozzle in a paint-tight manner. Due to gravity, paint can leak out of the paint container 11.1 through the open closure part 11.3 into the nozzle part 4. Paint is prevented from leaking out of the nozzle part 4 through the nozzle 54 by the nozzle tip 53 being pressed on as a result of the nozzle needle 5 being preloaded forwards.

In the rear region, but in front of the eye 55, the nozzle needle 5 has a piston 66 which is movably guided in a tubular rear extension 67 of the nozzle part 4. The piston 66 has a cylindrical outer surface and a larger cross-sectional diameter than the rest of the nozzle needle. An elastomeric sealing ring can be provided on the outer circumference of the piston 66. The sealing piston 66 prevents paint from leaking out of the nozzle part 4 at the rear.

To operate the paint spray gun 20, the switch 12 is first switched on, as a result of which the electric motor 28 is supplied with power and the fan 36 is driven. The fan generates a continuous air flow through the main body 22 from the air inlet opening to the spray opening 46. The air flow flows through an annular gap between the housing of the main body 22 and the nozzle part 4 and exits the main body 22 through air outlet openings (not shown) which are located in the air cap 3. The air outlet openings in the air cap 3 are arranged such that the corresponding air jets are inclined forwards and in the direction of the central axis of the nozzle needle 5.

In order to trigger the paint spraying process, the operator pulls the trigger 6 backwards counter to the force of the spring 62 using the fingers of the hand enclosing the handle 23. As a result, the trigger guard 6 pivots backwards about the pivot shaft 57 and moves the coupling pin 8 to the rear, said coupling pin running in the slot hole 56 and in the through-opening 49 which is designed as a slot hole in the process. The coupling pin 8 transforms a retraction of the actuating portion 45 by an operator into a movement of the nozzle needle 5 to the rear. More precisely, due to passing through the eye 55, the coupling pin 8 moves the nozzle needle 5 backwards counter to the force of the spring 52. As a result, the nozzle tip 53 moves away from the nozzle 54 and releases the nozzle opening in the nozzle 54, through which paint can exit the interior of the nozzle part 4 in the direction of the spray opening 46 to the outside. The air jets emerging from the air outlet openings in the air cap 3 entrain the paint in the manner of a suction jet pump, as a result of which a desired paint spray mist is established. The further the nozzle needle 5 is moved backwards by means of the trigger 6, the more paint exits the nozzle and therefore the higher the paint content in the spray mist.

To end the paint spraying process, the operator releases the trigger 6 using the fingers of the hand enclosing the handle 23. Due to the force of the spring 62, the trigger guard 6 pivots forwards about the pivot shaft 57. The coupling pin 8 is therefore moved forward, and runs in the slot hole 56 and in the through-opening 49 designed as a slot hole. As a result, and due to the force of the spring 52, the nozzle needle 5 is moved forwards until the nozzle tip 53 closes the nozzle 54 such that no paint can exit from the interior of the nozzle part 4 to the outside. Finally, the electric motor 28 and thus the fan 36 are switched off by actuating the switch 12.

1. A paint spray gun, comprising:
a main body, wherein the main body is tubular, wherein the main body has a spray opening on a first end face;
a handle that is provided on the main body and has an actuatable trigger;
a nozzle part arranged in the main body;
a nozzle needle that is movable in the nozzle part, with actuation of the actuatable trigger causing the nozzle needle to move in the nozzle part;
an air inlet opening; and
a fan which is driven by an electric motor and provided for generating an air flow from an air inlet opening to a spray opening, wherein the electric motor and the fan are arranged in the main body and the air inlet opening is arranged on an end face of the main body opposite the first end face.

2. The paint spray gun according to claim 1, wherein a filter for filtering the air flow flowing through the main body is provided in the region of the air inlet opening.

3. The paint spray gun according to claim 2, wherein the filter is held on the main body by a filter cap through which a flow can pass.

4. The paint spray gun according to claim 1, wherein a coupling pin is provided for transmitting the actuating forces from the trigger to the nozzle needle.

5. The paint spray gun according to claim 4, wherein the nozzle part has at least one through-opening through which the coupling pin can pass.

6. The paint spray gun according to claim 4, wherein the through-opening is designed as a slot hole.

7. The paint spray gun according to claim 4, wherein the coupling pin has a grip at one end which allows an operator to manually pull the coupling pin out of the main body.

8. The paint spray gun according to claim 1, wherein the paint spray gun has an on/off switch which can be switched independently of the actuation of the trigger and is provided for switching the fan on and off.

9. The paint spray gun according to claim 1, wherein the paint spray gun has an accumulator for supplying electricity to the electric motor.

10. The paint spray gun according to claim 9, wherein the accumulator is arranged on the side of the handle opposite the main body.

11. The paint spray gun according to claim 9, wherein the accumulator is arranged in an accumulator unit which can be removed from the paint spray gun.

12. The paint spray gun according to claim 1, further comprising:
a receptacle for a paint container unit provided on the side of the main body opposite the handle, wherein guide elements for a rotary closure of the paint container unit are provided in the receptacle.

13. The paint spray gun according to claim 12, further comprising:
a paint container unit which has a rotary closure, wherein guide elements which interact with the guide elements of the receptacle are provided on the rotary closure.
